(19) United States
(12) Patent Application Publication
(10) Pub. No.: US 2007/0176903 A1
(43) Pub. Date: Aug. 2, 2007

(54) Capacitive touch sensor button activation

(76) Inventors: Jeffrey J. Dahlin, Kenmore, WA (US); Craig Nemecek, Seattle, WA (US); Andrew Page, Kirkland, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/343,402

(22) Filed: Jan. 31, 2006

(51) Int. Cl. G09G 5/00; G06F 3/02

(52) U.S. Cl. 345/169

(57) ABSTRACT

A first touch is sensed at a first button on a capacitive touch sensor. A second button on the capacitive touch sensor is activated using one of a search-and-tap technique or a search-and-lift technique.

### TECHNICAL FIELD

Embodiments of the invention relate to the field of capacitive touch sensors and more specifically, but not exclusively, to capacitive touch sensor button activation.

### BACKGROUND

Accidental key press is a concern when implementing a capacitive touch sensor in a keypad. A traditional search-and-press technique involves the user finding the desired key (usually visually), and then pressing the desired button to activate the button. Accidental key press is especially a problem when trying to physically locate the correct key to be selected. For example, when trying to dial a number on a phone keypad with the traditional search-and-press technique using only one hand, a person will typically place their thumb on the keypad, move their thumb to the correct key, and then press. With capacitive touch sensor keypads, moving the thumb over various keys results in multiple unwanted key presses.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a search-and-tap capacitive touch sensor button activation technique in accordance with an embodiment of the invention.

FIG. 2 is a flowchart illustrating the logic and operations of a search-and-tap capacitive touch sensor button activation technique in accordance with an embodiment of the invention.

FIG. 3 is a diagram illustrating a search-and-lift capacitive touch sensor button activation technique in accordance with an embodiment of the invention.

FIG. 4 is a flowchart illustrating the logic and operations of a search-and-lift capacitive touch sensor button activation technique in accordance with an embodiment of the invention.

FIG. 5A is a diagram illustrating a scroll wheel capacitive touch sensor in accordance with an embodiment of the invention.

FIG. 5B is a diagram illustrating a slider capacitive touch sensor in accordance with an embodiment of the invention.

FIG. 6 is a diagram illustrating embodiments of a mobile device to utilize embodiments of capacitive touch sensor button activation as described herein.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the invention include capacitive touch sensor button activation techniques to avoid accidental key presses. Such techniques include a search-and-tap technique and a search-and-lift-technique. These techniques enable a user to find and activate buttons without visual reference to the capacitive touch sensor.

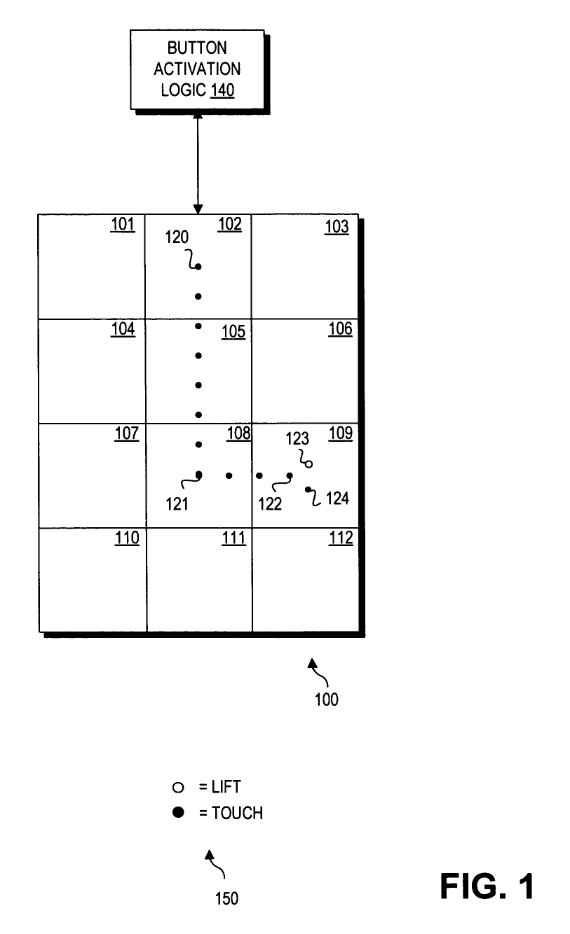

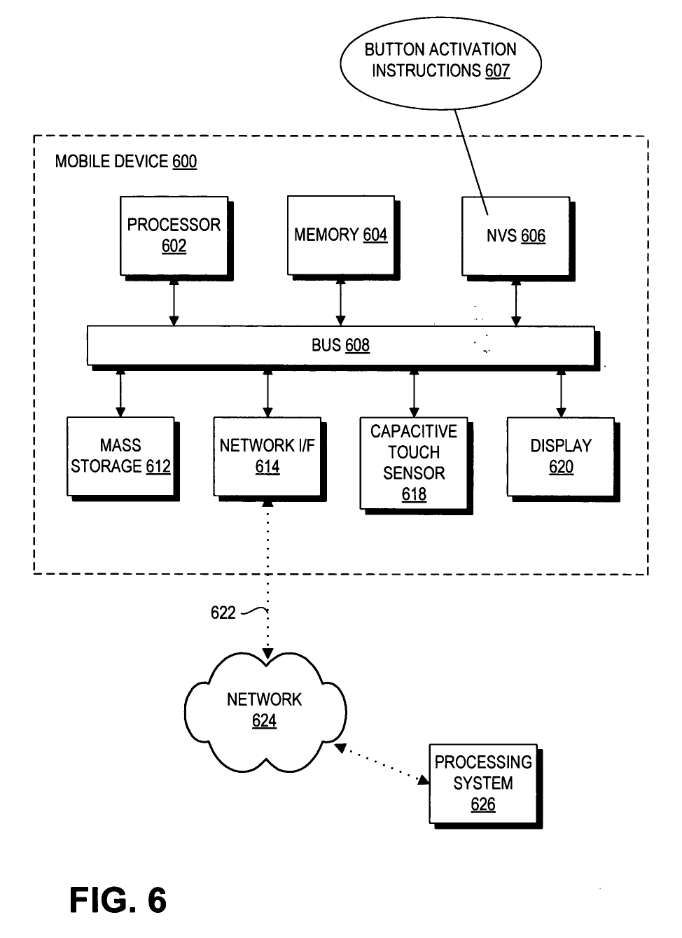

Turning to FIG. 1, a capacitive touch sensor 100 is shown. FIG. 1 shows a capacitive touch sensor 100 utilized as a keypad. In one embodiment, sensor 100 may be part of a mobile device, such as a mobile phone. Embodiments of a mobile device will discussed below in conjunction with FIG. 6. While embodiments herein are described in relation to a keypad, it will be understood that embodiments of the invention may be utilized with alternative capacitive touch sensor controls, such as a scroll wheel, slider, or the like. It will also be understood that the terms “key” and “button” are used herein interchangeably.

In one embodiment, capacitive touch sensor 100 is logically divided into keys 101-112. In one embodiment, keys 101-112 may correspond to traditional phone keys, however, embodiments herein are not limited to phone keys.

A touch, such as by a finger, on capacitive touch sensor 100 is detected by embedded sensors and indicates where the user has touched sensor 100. An X-Y position on sensor 100 where the touch is sensed is translated to a particular key.

In alternative embodiments, two or more capacitive touch sensors may be combined to form keys 101-112. For example, keys 101-106 may be associated with one capacitive touch sensor and keys 107-112 may be associated with another sensor. Button activation logic 140 translates the X-Y positioning of a touch on one of the sensors to a particular key.

Sensor 100 may include an overlay (not shown) that includes physical keys associated with capacitive touch sensor keys 101-112. In one embodiment, such physical keys may be printed with symbols to indicate to a user the positions of the keys. In another embodiment, the overlay may include physical locating elements, such as embossed keys or key outlines, to help the user locate the desired key without looking at the keypad. In another embodiment, a single key may have an associated physical locating element, such as a raised bump, to allow the user to know where their thumb/finger is on the keypad and dial the phone without looking at the keypad.

It will be understood that the term “touch” as used herein includes direct physical contact with sensor 100 and indirect physical contact with sensor 100. In an example of indirect physical contact, one or more layers of material, such as a plastic key layer, may be placed on top of sensor 100 such that a user's finger makes direct physical contact with the plastic key layer and not directly with sensor 100. However, in this case, a touch may still be detected by sensor 100.

In one embodiment, capacitive touch sensor 100 includes CapSense™ technology as promulgated by the Cypress Semiconductor Corporation. CapSense™ may be used with Cypress's family of Programmable System-on-Chip™ (PSoC™) devices. PSoC devices include configurable mixed signal arrays.

Embodiments of the invention include a search-and-tap capacitive touch sensor button activation technique. These techniques may be implemented in a button activation logic 140 coupled to capacitive touch sensor 100. Button activation logic 140 may include hardware, software, or any combination thereof.

In search-and-tap, the device user may put a finger in contact with the capacitive touch sensor and move their finger around the keypad to search for the desired key. Then, when the user wants to select the desired key, rather than pressing the key, the user lifts their finger and returns it to the same key. The key is “pressed” by lifting the finger and returning it to the same key instead of only pressing the finger down.

The touch sensor button activation logic 140 may allow the user to move their finger around to different keys without causing a key press to be registered. For example, moving from key A to key B to Key C, etc., would not result in any key being selected. However, a transition from key A to no key (i.e., a lift) and back to key A would result in key A being selected.

An example of search-and-tap is shown in FIG. 1. As shown at 150, a solid circle represents a touch and an open circle represents a lift. A user's finger is placed on key 102 (shown at 120). The user drags their finger across key 105 to key 108 (shown at 121) maintaining contact with sensor 100. The user then drags their finger to key 109 (shown at 122) maintaining contact with sensor 100. The user then lifts their finger (shown at 123) and then touches key 109 a second time (as shown at 124). The sensing of the second touch at key 109 initiates the activation of key 109.

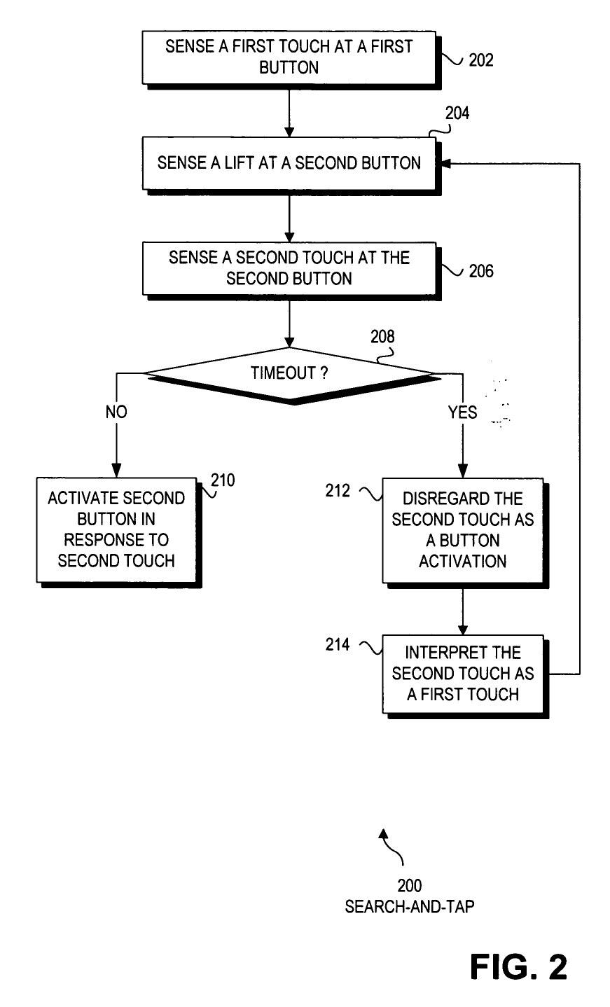

Turning to FIG. 2, a flowchart 200 of an embodiment of a search-and-tap technique is shown. Embodiments of flowchart 200 may be implemented as instructions executable by a processor on a mobile device having a capacitive touch sensor. The logic of flowchart 200 may be implemented as software, hardware, or any combination thereof.

Starting in a block 202, a first touch is sensed by a capacitive touch sensor at a first button on the sensor. Proceeding to a block 204, a lift is sensed at a second button on the sensor. A lift may include a sensed touch that ceases being detected. Continuing to a block 206, a second touch is sensed at the second button. A drag may be sensed from the first button to the second button without activating any buttons on the capacitive touch sensor.

In one embodiment, the first and second buttons may be associated with the same button. For example, in FIG. 1, the user may touch key 101 (i.e., a first button), lift their finger, and return their finger to key 101 (i.e., a second button) to activate key 101.

The logic then proceeds to decision block 208 to determine if the time between the first and second touches has exceeded a timeout threshold. If the timeout threshold has not been exceeded, then the logic proceeds to a block 210 to activate the second button in response to the second touch.

If the timeout threshold has been exceeded, then the logic proceeds to a block 212 to disregard the second touch as a button activation. In this instance, the user's finger has been off of the sensor for too long between the first and second touches. This second touch may be interpreted as a first touch, as shown in block 214. After block 214, the logic returns to block to block 204 when a lift is sensed.

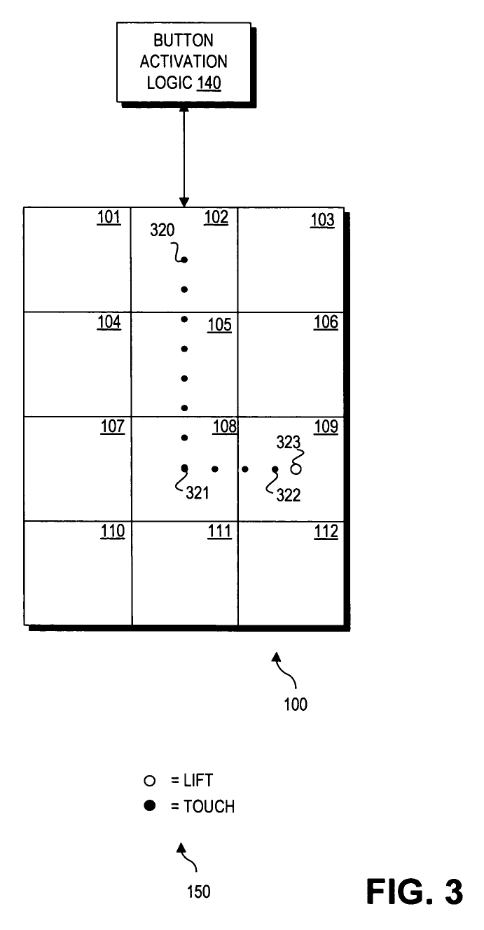

Turning to FIG. 3, capacitive touch sensor 100 utilizing an embodiment of a search-and-lift capacitive touch sensor button activation technique is shown. In one embodiment, search-and-lift defines a key press as key A to no key. This technique has the similar effect as the traditional search-and-press; the process of tapping the key results in that key being selected once. The search-and-lift technique may work equally well with holding the device with one hand and dragging the thumb around (one-handed technique) or with holding the device with one hand and typing with the other hand (two-handed technique).

An example of search-and-lift is shown in FIG. 3. A user places their finger on key 102 (shown at 320). The user drags their finger across key 105 to key 108 (shown at 321) maintaining contact with sensor 100. The user then drags their finger from key 108 to key 109 (shown at 322) maintaining contact with sensor 100. The user then lifts their finger off of sensor 100 (as shown at 323). The lift (i.e., the absence of sensed touch on sensor 100) from sensor 100 at key 109 activates key 109.

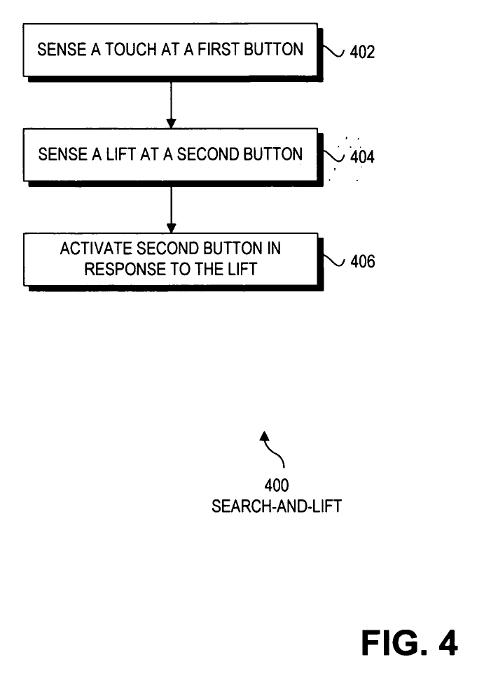

Turning to FIG. 4, a flowchart 400 of an embodiment of a search-and-lift technique is shown. Embodiments of flowchart 400 may be implemented as instructions executable by a processor on a mobile device having a capacitive touch sensor. The logic of flowchart 400 may be implemented as software, hardware, or any combination thereof.

Starting in a block 402, a touch is sensed at a first button on a capacitive touch sensor. Proceeding to a block 404, a lift is sensed at a second button on the sensor. Continuing to a block 406, the second button is activated in response to the lift. A drag may be sensed from the first button to the second button without activating any buttons on the capacitive touch sensor.

In one embodiment, the first and second buttons may be the same button. For example, the user may place their finger on key 101 and lift their finger from key 101 resulting in the activation of key 101.

From the user's perspective, the search-and-lift technique has the feel of traditional search-and-press. However, the user may also drag their finger around the keypad without activating any keys until their finger is lifted. This enables a user to “feel around” the keypad for the desired key without looking at the keypad as well as preventing any unwanted key presses. The user may identify the location of their finger on the keypad without looking at the keypad by using physical locating elements as discussed above.

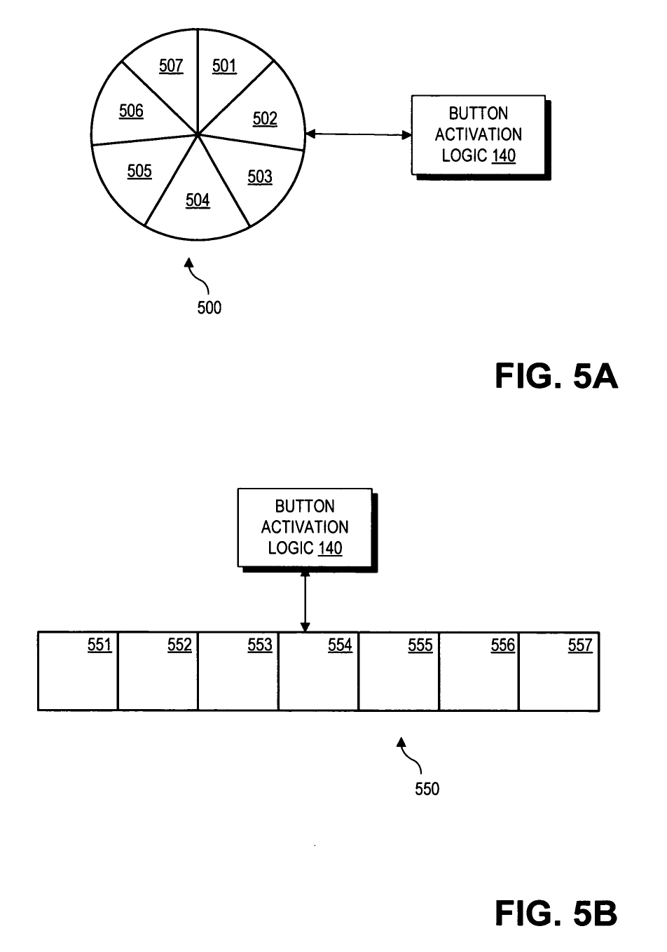

Turning to FIG. 5A, an embodiment of a capacitive touch sensor scroll wheel 500 coupled to button activation logic 140 is shown. Scroll wheel 500 is logically divided into buttons 501-507. Scroll wheel 500 may utilize a search-and-tap or a search-and-lift technique as directed by button activation logic 140. Scroll wheel 500 is not limited to the button arrangement shown in FIG. 5. Scroll wheel 500 may use an X-Y matrix to determine a button associated with a particular touch position or area.

FIG. 5B shows an embodiment of a capacitive touch sensor slider 550 coupled to button activation logic 140. Slider 550 is logically divided into buttons 551-557. In one embodiment, slider 550 may be used for linear control applications, such as a volume control, a speed control, such as on a treadmill, or the like.

Embodiments of the invention provide for use of a capacitive touch sensor without having to visually reference the buttons of the sensor. Embodiments herein allow a user to avoid accidental key presses, such as when dialing a mobile phone with one hand. Button activation techniques described herein may be applied to a variety of capacitive touch sensor applications, such as keypads, scroll wheels, and slider controls.

FIG. 6 illustrates embodiments of a mobile device 600 on which embodiments of the present invention may be implemented. Mobile device 600 includes a processor 602 and a memory 604 coupled to a bus 608. Mass storage 612, Non-Volatile Storage (NVS) 606, network interface (I/F) 614, capacitive touch sensor 618, and display 620 may also be coupled to bus 608. Embodiments of mobile device 600 include, but are not limited to, a mobile phone, a media player, a personal digital assistant, a pocket personal computer (PC), a notebook computer, or the like.

In one embodiment, mobile device 600 includes processor 602 coupled to memory 604 and NVS 606. Processor 602 may execute instructions loaded into memory 604 from NVS 606. In one embodiment, button activation instructions 607 for one or more button activation techniques as described herein are stored in NVS 606 for use with capacitive touch sensor 618. In one embodiment, mobile device 600 may include menu options for the user to select the desired button activation technique including search-and-tap and search-and-lift.

Memory 604 may include, but is not limited to, Dynamic Random Access Memory (DRAM), Static Random Access Memory (SRAM), Synchronized Dynamic Random Access Memory (SDRAM), or the like. In one embodiment, memory 604 may include one or more memory units that do not have to be refreshed.

Components of mobile device 600 may be connected by various interconnects, such as bus 608. In one embodiment, an interconnect may be point-to-point between two components, while in other embodiments, an interconnect may connect more than two components.

Mobile device 600 may interface to external systems through network interface 614 using a wired connection, a wireless connection, or any combination thereof. Network interface 614 may include, but is not limited to, a modem, a Network Interface Card (NIC), or the like. Network interface 614 may include a wireless communication module. The wireless communication module may employ a Wireless Application Protocol to establish a wireless communication channel. The wireless communication module may implement a wireless networking standard.

A carrier wave signal 622 may be received/transmitted by network interface 614. In the embodiment illustrated in FIG. 6, carrier wave signal 622 is used to interface mobile device 600 with a network 624, such as a Local Area Network (LAN), a Wide Area Network (WAN), a mobile phone telecommunications network, or the like. In one embodiment, network 624 is further coupled to a processing system 626 such that mobile device 600 and processing system 626 may communicate over network 624. Processing system 626 may include a mobile device, such as a mobile phone, a computer system, or the like.

Mobile device 600 may include non-volatile storage 606 on which firmware may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), Non-Volatile Random Access Memory (NVRAM), or the like.

Mass storage 612 includes, but is not limited to, a magnetic disk drive, such as a hard disk drive, an optical disk drive, or the like. It is appreciated that instructions executable by processor 602 may reside in mass storage 612, memory 604, non-volatile storage 606, or may be transmitted or received via network interface 614.

In one embodiment, mobile device 600 may execute an Operating System (OS). Embodiments of an OS include a Microsoft Windows® operating system, an Apple® operating system, or the like. In one embodiment, instructions for executing an OS may be stored on mass storage 612.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., Read-Only Memory (ROM), Random Access Memory (RAM), magnetic disk storage media, optical storage media, a flash memory device, etc.). In addition, a machine-readable medium may include propagated signals such as electrical, optical, acoustical or other forms of propagated signals (e.g., carrier waves, infrared signals, digital signals, etc.).

Various operations of embodiments of the present invention are described herein. These operations may be implemented using hardware, software, or any combination thereof. These operations may be implemented by a machine using a processor, an Application Specific Integrated Circuit (ASIC), a Field Programmable Gate Array (FPGA), or the like. In one embodiment, one or more of the operations described may constitute instructions stored on a machine-readable medium, that if executed by a machine, will cause the machine to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
sensing a first touch at a first button on a capacitive touch sensor; and
activating a second button on the capacitive touch sensor using one of a search-and-tap technique or a search-and-lift technique.

2. The method of claim 1 wherein the search-and-tap technique includes:
sensing a lift at the second button on the capacitive touch sensor;
sensing a second touch at the second button on the capacitive touch sensor; and
activating the second button in response to the second touch.

3. The method of claim 2, further comprising determining whether a time between the first touch and the second touch exceeds a timeout threshold.

4. The method of claim 1 wherein the search-and-lift technique includes:
sensing a lift at the second button on the capacitive touch sensor; and
activating the second button in response to the lift.

5. The method of claim 1, further comprising sensing a drag from the first button to the second button without activating any buttons on the capacitive touch sensor.

6. The method of claim 1 wherein the first button and the second button are a same button.

7. The method of claim 1 wherein the capacitive touch sensor includes a physical locating element to enable a user to find the first button without looking at the capacitive touch sensor.

8. An article of manufacture, comprising:
a machine-readable medium including instructions that, if executed by a machine, cause the machine to perform operations comprising:
sensing a first touch at a first button on a capacitive touch sensor; and
activating a second button on the capacitive touch sensor using one of a search-and-tap technique or a search-and-lift technique.

9. The article of manufacture of claim 8 wherein the search-and-tap technique includes:
sensing a lift at the second button on the capacitive touch sensor;
sensing a second touch at the second button on the capacitive touch sensor; and
activating the second button in response to the second touch.

10. The article of manufacture of claim 9 wherein the machine-readable medium further includes instructions that, if executed by the machine, cause the machine to perform operations comprising:
determining whether a time between the first touch and the second touch exceeds a timeout threshold.

11. The article of manufacture of claim 8 wherein the search-and-lift technique includes:
sensing a lift at the second button on the capacitive touch sensor; and
activating the second button in response to the lift.

12. The article of manufacture of claim 8 wherein the machine-readable medium further includes instructions that, if executed by the machine, cause the machine to perform operations comprising:
sensing a drag from the first button to the second button without activating any buttons on the capacitive touch sensor.

13. The article of manufacture of claim 8 wherein the first button and the second button are a same button.

14. The article of manufacture of claim 8 wherein the capacitive touch sensor includes a physical locating element to enable a user to find the first button without looking at the capacitive touch sensor.

15. A mobile device, comprising:
a processor;
a capacitive touch sensor coupled to the processor;
a storage unit coupled to the processor, wherein the storage unit including instructions that, if executed by the processor, will cause the processor to perform operations comprising:
sensing a first touch at a first button on the capacitive touch sensor; and
activating a second button on the capacitive touch sensor using one of a search-and-tap technique or a search-and-lift technique.

16. The mobile device of claim 15 wherein the search-and-tap technique includes:
sensing a lift at the second button on the capacitive touch sensor;
sensing a second touch at the second button on the capacitive touch sensor; and
activating the second button in response to the second touch.

17. The mobile device of claim 16 wherein the machine-readable medium further includes instructions that, if executed by the machine, cause the machine to perform operations comprising:
determining whether a time between the first touch and the second touch exceeds a timeout threshold.

18. The mobile device of claim 15 wherein the search-and-lift technique includes:
sensing a lift at the second button on the capacitive touch sensor; and
activating the second button in response to the lift.

19. The mobile device of claim 15 wherein the first button and the second button are a same button.

20. The mobile device of claim 15 wherein the capacitive touch sensor includes a physical locating element to enable a user to find the first button without looking at the capacitive touch sensor.
